(19) United States
(12) Patent Application Publication
(10) Pub. No.: US 2019/0017534 A1
(43) Pub. Date: Jan. 17, 2019

(54) Cema Locks

(71) Applicant: Miguel Angel Carranco, Irving, TX (US)

(72) Inventor: Miguel Angel Carranco, Irving, TX (US)

(21) Appl. No.: 16/035,432

(22) Filed: Jul. 13, 2018

Related U.S. Application Data
(60) Provisional application No. 62/532,374, filed on Jul. 14, 2017.

(51) Int. Cl. F16B 41/00; F16B 39/22

(52) U.S. Cl. CPC F16B 41/005; F16B 39/22

(57) ABSTRACT

A device comprising a lug nut designed with a locking mechanism inside and a miniature tubular cam lock.

### CROSS-REFERENCE TO RELATED APPLICATIONS

Applicant claims priority to U.S. Provisional Patent Application No. 62/532,374, filed Jul. 14, 2017, the disclosure of which is incorporated by reference herein in its entirety.

### DETAILED DESCRIPTION

This product is a lug nut or fastener nut designed with a locking mechanism inside and a miniature tubular cam lock. The outside part of the lug nut is designed to free spin when the cam lock key is turned at 90 degrees and it's supposed to stop from free spinning when the tubular key is turned back to its original position allowing for the removal of a person's wheel should he or she need to remove the tire. It is a new innovative type of lug nut system/wheel lock system from the lug nut design to the key concept. No more keeping a big bulky wheel lock key somewhere inside a vehicle. The key in this system is portable enough to allow it to be carried around on a keychain. It is no bigger than a mail box key. This way the key is always in the vehicle when the vehicle is being operated and it's within reach should the need to take the wheel come up, or it is on a key chain inside the place of residence or always on a person's body. This system is designed to deter would be thieves from trying to steal wheels from a vehicle.

What is claimed is:

1. A device comprising:
a lug nut designed with a locking mechanism inside; and
a miniature tubular cam lock.
